(19) United States
(12) Patent Application Publication
(10) Pub. No.: US 2009/0240587 A1
(43) Pub. Date: Sep. 24, 2009

(54) METHOD OF SEARCHING FOR BUSINESS OFFERS

(76) Inventor: Arthur J. EMANUELE, Tempe, AZ (US)

Correspondence Address: HOLME ROBERTS & OWEN LLP, 16427 N. SCOTTSDALE RD., SUITE 300, SCOTTSDALE, AZ, 85254, US

(21) Appl. No.: 12/406,818

(22) Filed: Mar. 18, 2009

Related U.S. Application Data
(60) Provisional application No. 61/069,887, filed on Mar. 18, 2008.

(51) Int. Cl. G06Q 30/00; G06F 17/30

(52) U.S. Cl. 705/14; 705/26; 707/3; 707/E17.014

(57) ABSTRACT

This invention relates generally to a system and method for potential consumers to find business offers and business hours based on a variety of alternative criteria, and more particularly to a system and method for providing a user or searcher with search results based on a business' days and hours of operation, days and/or hours that it offers particular deals or other similar criteria. The system and method is applicable to a wide variety businesses and deals, including, but not limited to, restaurants, grocery stores, service providers and any other business that typically offers day or time-based discounts, deals or other offers.

### CLAIM TO DOMESTIC PRIORITY

The present application claims the benefit of U.S. Provisional Patent Application No. 61/069,887 filed on Mar. 18, 2008, entitled “Method of Searching for Business Offers,” the entire disclosure of which is incorporated herein by reference in its entirety for all purposes.

### FIELD OF THE INVENTION

This invention relates generally to a system and method for potential consumers to find business offers and business hours based on a variety of alternative criteria, and more particularly to a system and method for providing a user or searcher with search results based on a business' days and hours of operation, days and/or hours that it offers particular deals or other similar criteria. The system and method is applicable to a wide variety of businesses and deals, including, but not limited to, restaurants, grocery stores, service providers and any other business that typically offers day or time-based discounts, deals or other offers.

### BACKGROUND OF THE INVENTION

Consumers are often looking to find offers, discounts, coupons, or other deals, based upon a certain day, time and location in which they want to take advantage of an offer. For example, some consumers may want to do their shopping on their day off. In other cases, some consumers may want to eat a particular type of food on a particular night and have dinner at a particular time. Presently no system or method exists to allow consumers to easily and efficiently look for time, day and location-based business offers without having to look through multiple store or business flyers or do multiple Internet searches, looking at each businesses offers or specials individually.

### BRIEF DESCRIPTION OF THE DRAWINGS

FIG. 1 is an illustration of the system according to one embodiment of the present disclosure.

FIG. 2 is an example of an array of potential businesses and service providers that would generate search results according to one embodiment of the present invention.

FIG. 3 is a schematic flow diagram illustrating he steps of the Internet-based search system according to one embodiment of the present invention.

FIGS. 3A-3E are further schematic flow diagrams following in extension of FIG. 3, as described further in the detailed description.

FIGS. 3F-3H are, in the manner, schematic flow diagrams further illustrating the schematic flow diagram from FIG. 3A.

FIGS. 3I-3K are, in the same manner, schematic flow diagrams further illustrating the schematic flow diagram from FIG. 3B.

FIGS. 4A-4C are examples of screen shots of the search system user interface as it appears to consumers desiring to search for business offers, including various levels of searching capabilities.

FIG. 5 is a screen shot of data entered into the search system user interface by consumers desiring to search for a particular offer on hot wings at the displayed time, day and location.

FIG. 6 is a screen shot of the results returned following execution of the search specified in FIG. 5 by the server computer.

### DETAILED DESCRIPTION OF VARIOUS EMBODIMENTS

The present invention is directed to a system and method for potential consumers to find business offers and business hours based on a variety of alternative criteria, and more particularly to a system and method for providing a user or searcher with search results based on a business' days and hours of operation, days and/or hours that it offers particular deals or other similar criteria. The system and method is applicable to a wide variety businesses and deals, including, but not limited to, restaurants, grocery stores, service providers and any other business that typically offers day or time-based discounts, deals or other offers

The system and method are also capable of notifying potential consumers when a particular business or business in a pre-selected category is offering one or more deals on items in general or of certain pre-selected items. Thus, the present system and method is capable of providing consumers with a targeted list of deals resulting in a more effective and efficient search engine for shopping for a plethora of products, services and other deals.

Practically, the present system provides a method for consumers for reducing time and effort in searching for day and time based offers, while allowing merchants to more effectively market. Thus, one advantage of the present system and method is providing a consumer benefit of “one-stop” shopping that, at least in one embodiment, is free of charge. A second advantage of the present system and method is providing a benefit to merchants in leveraging consumer intelligence data, which increases sales and allows business resources to be allocated more effectively.

It is envisioned that the server website and webpages according to one embodiment of the present invention is the place to find any local deal, special, promotion, sale, or other coupon-like discounts. The primary advantage of the disclosed website is the unique mechanism disclosed herein for users or search to conduct day and time-range searches. Users or deal-searchers no longer have to go through hundreds of offers just to find one that is valid during the day and time the searcher is looking for. For example, the presently disclosed system and method is ideal for finding food and drink specials, among thousands of other offers and deals.

Before proceeding to a detailed description of the figures, some preliminary connotational matters will be addressed. The term “business offer” or “offer” is defined to include, but not be limited to, any offer made to a consumer for purchase of any product or service, download of any product or service, including online delivery of video, software or music via the Internet, pick-up or delivery of food, groceries, goods, services, other services provided in the home, such as lawn care, housecleaning, laundry services and pool services, and entertainment, such as live music, concerts, theatre, dance, comedy and so forth. In the present disclosure, the term business offer or offer is interchangeable with the term “deal.”

The term “business offer” according to the present disclosure specifically excludes advertisements and offers for airline tickets, rental cars and hotels. Further, the search system disclosed herein is not merely a reservation system that searches for availability of seats on airplanes, empty hotel rooms or available restaurant tables. The novelty of the present application is focused on a search system which searches a comprehensive collection of a wide variety of businesses and business services in a particular locale, including day and time of operation and day or time-dependant offers from those businesses, so as to make consumer searching for particular business offers, deals or discounts, within a desired distance from their particular location, much more efficient and effective than any system that presently exists.

However, it is specifically noted that in order to fall under the definition of “business offer” in the present disclosure, the price of the good, service, entertainment or other advertisement does not need to reflect a discounted price or “deal” in the traditional sense of receiving a lower price than normally offered. Here, “business offer” is defined as an offer that could simply be an advertisement for a good or service at the regular or standard price.

The term “host server” designates the server on which a “host web site” will be maintained. A host web site comprises one or more web pages, including, but not limited to: a home page, a contests page, a photo gallery page, a contact page, a consumer account page, a merchant page, blog pages, chat rooms, consumer rating pages, and so forth.

The terms “host,” “host server,” and “host web site” will be used interchangeably since in one embodiment, the host server is accessed through the Internet or World Wide Web, as a web site. However, a “portal” will be used to refer to a web page or merchant access point on the host web site. The present system and method allow for a merchant to be given, purchase or license a portal on the host web site for its use.

Additionally, while it is recognized that there is a technological distinction between Internet and World Wide Web, the terms are seemingly interchangeable and used as such throughout this description. The use of these terms in this fashion is for descriptive convenience only. The skilled artisan will appreciate that the system encompasses the technological context of both the Internet and the World Wide Web.

Further, reference to “data” or “data storage” will refer to information stored on the “host server” and transmitted, in one embodiment, from a consumer, via the Internet from the consumer's personal computer or other personal electronic device capable of Internet communication. The transmission of data from the host server to the businesses is also envisioned to occur via Internet transmission or other secure electronic transmission from the host server to the business' computer server.

The terms “user,” “searcher,” “consumer,” “recipient,” “subscriber,” and “customer” will be used interchangeably. Specifically, the terms “consumer,” “subscriber,” “customer,” and “recipient” are used alternately to designate any person, business, or any other entity that receives communications from any other entity, including all types of businesses and organizations. Similarly, “merchant” or “business” will be used interchangeably and will be used herein to designate any entity sending communications that are the subject of the present system and method. According to the present disclosure, the consumer is made aware of the disclosed system and method through print advertisement, Internet advertisements, or by searching the Internet for capture consumer preferences web sites.

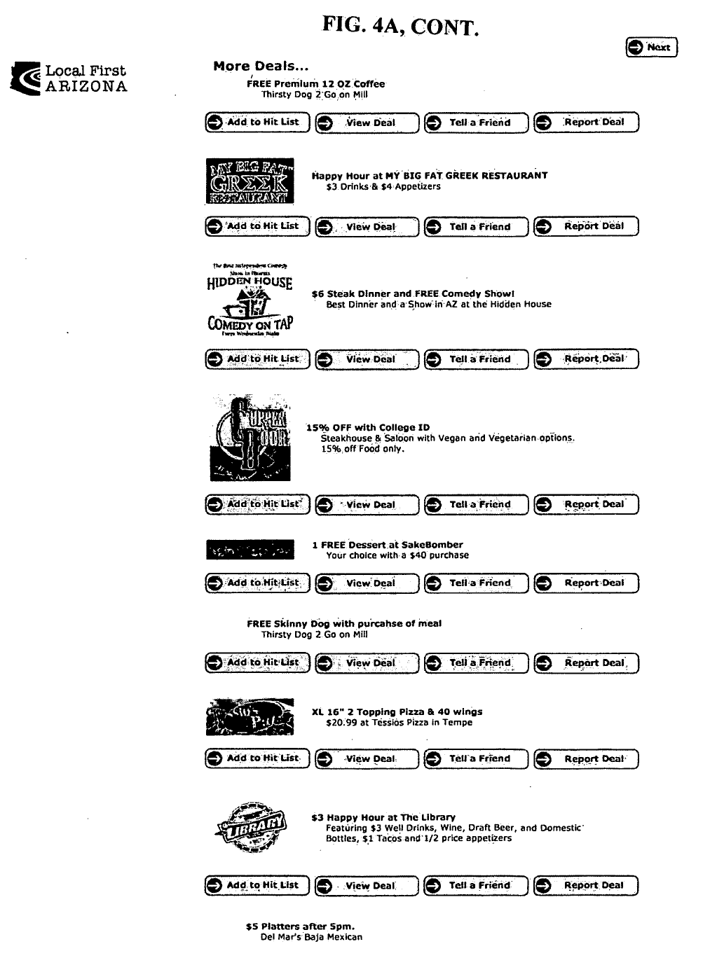

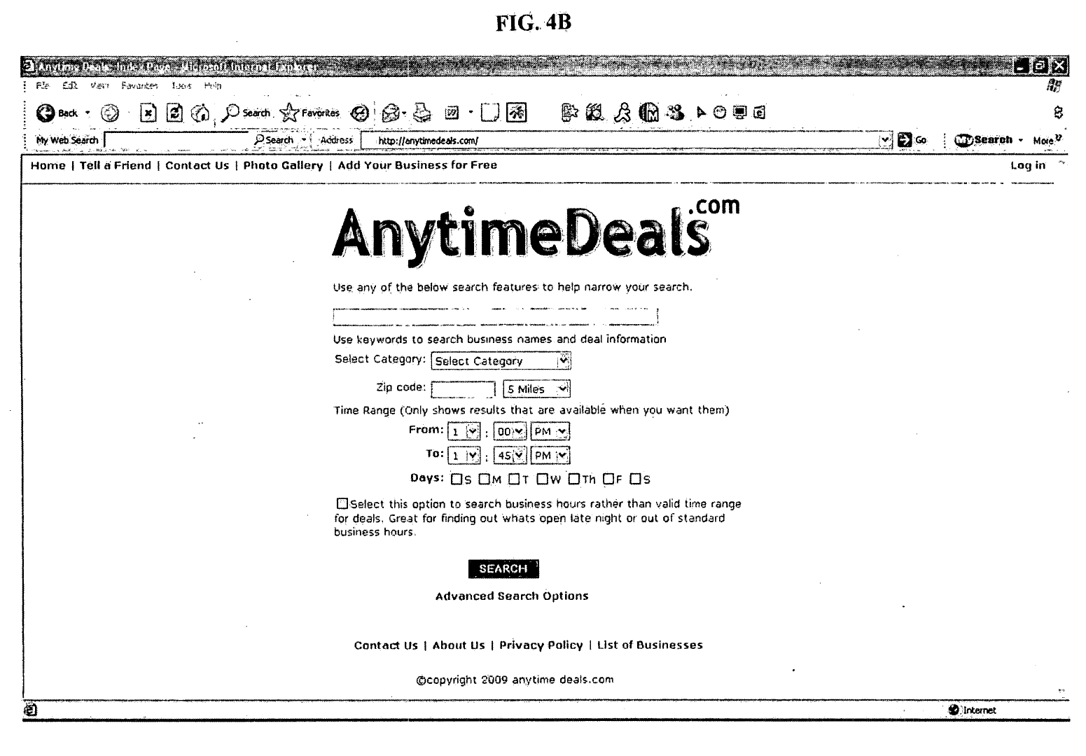

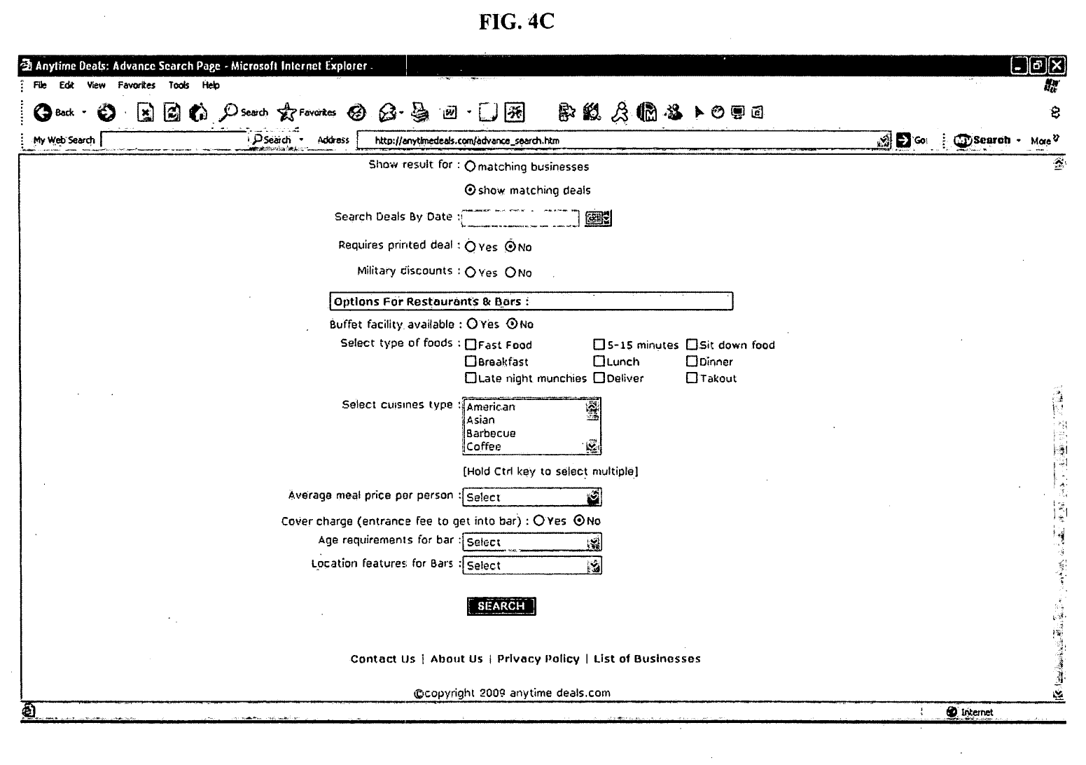

“Input data” as defined in the present includes, but is not limited to, any parameter defined by the host server and presented to the consumer that can be used by the host server to identify and return matching search results (business offers). Examples of input data include business category, date, time, location, printed coupon required (yes or no), additional discounts available (military, AARP, AAA, etc), age requirements and average price. Depending on the business category, additional criteria or data may be input to further define or limit the search results. FIG. 4C provides an example of additional limiting input data for restaurants and bars.

According to all embodiments of the present disclosure the minimum input data requirement in order to return a result includes at least one keyword, a day (or date) and a time parameter. If no particular day is selected, the search system will use the following parameter: “Monday or Tuesday or Wednesday or Thursday or Friday or Saturday or Sunday.” If no particular time or time range is designated, the system will use the following parameter: “12:00 am to 11:59 pm.” Thus, an example of qualifying input data would be “hot wings” and “Friday” and “9 pm.”

Further, according to an alternate embodiment of the present disclosure, input data and parameters can be automatically entered by the consumer computer used to communicate with the host server. For example, the presently disclosed search system is capable of receiving a location input data parameter from a consumer computer or device with a GPS. Thus, consumers, without need to manually enter a location input data point, would receive business offers at or near their present location, as determined from the GPS data transmitted by their device in communication with the host server.

In the same manner, date and time input data points would also be automatically transmitted from the consumer computer (including any computing device in communication with the host server, such as cell phone, pda, etc.). Based on the current date and time transmitted to the host server by the computing device, the consumer, without having to manually enter the present date and time, would receive business offers presently available at the current date and time. Thus, in an alternate embodiment of the present disclosure, a consumer would access the host website, enter a keyword, such as “hot wings” and select the “HERE AND NOW” feature, and receive results of all hot wing-associated business offers within a five mile radius (or other preset radius) that are presently available. Additionally then, the SHOW feature would provide all businesses currently open (at the present day and time) with a five mile radius that sell hot wings.

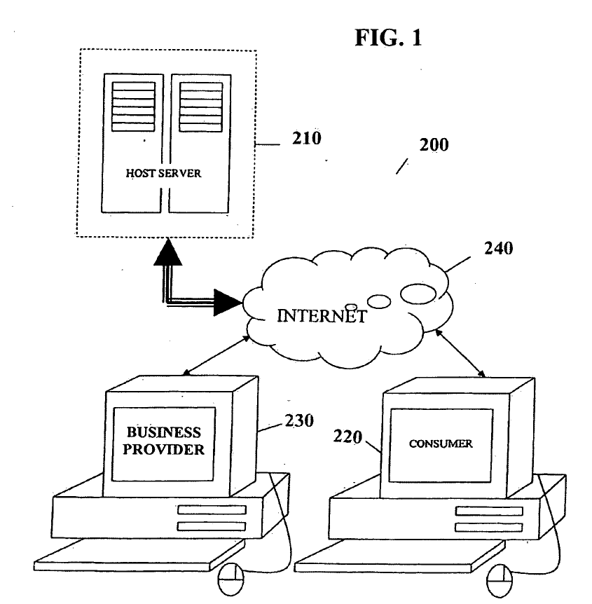

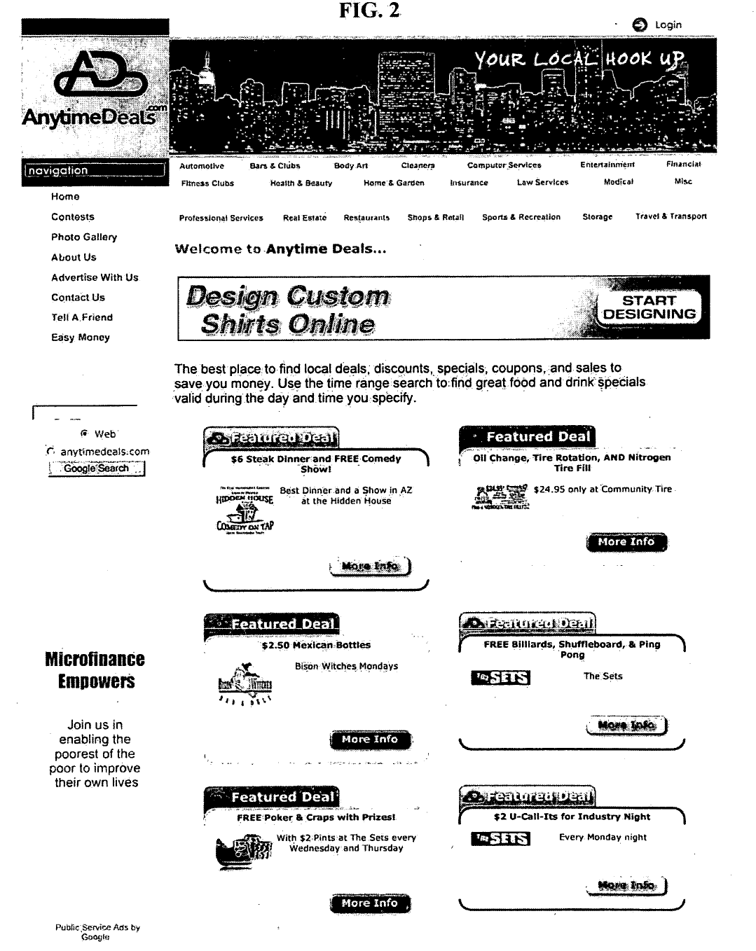

Turning now to the figures, FIG. 1 illustrates one embodiment of a system 200 for carrying our the invention. System 200 includes one or more host servers 210, one or more consumers 220, and one or more businesses 230. As shown in FIG. 1, the consumer 220 communicates with the host server 210 directly via the Internet 240.

As noted above, the host server 210 includes a host web site, for example, the stored in unillustrated memory, with the web site including one or more web pages. More specifically, the web pages are formatted and developed using Hyper Text Markup Language (HTML) code. As known in the art, an HTML web page includes both “content” and “markup” portions. The content portion is information that describes a web page's text or other information for display or playback on a computer or other personal electronic device via a display screen, audio device, DVD device or other multimedia device. The markup portion is information that describes the web page's behavioral characteristics, including how the content is to be displayed (e.g., the frame set) and how other information can be accessed (e.g., hyperlinks). Thus the HTML code that marks up formatted web pages of the host web site of one described embodiment displayed in selected, predetermined display regions of a single region of a single computer or other electronic device display screen. It is appreciated that other languages, such as SMGL (“Standard Generalized Markup Language”), XML (“Extensible Markup Language”) DHMTL (“Dynamic Hyper Text Markup Language”), Java, Flash, Quick Time, or any other language for implementing web pages could be used.

The computer or device used by consumer 220 in communicating with the host server 210 are any type of computing device capable of accessing the host server 210 through a host web site via the Internet 240, and capable of displaying the host server's 210 stored web pages using well-known web browser software packages, or any other web browser software. Such computing devices or other electronic devices include, but are not limited to, personal computers (PCs), both IBM-compatible and MacIntosh; hand-held computing devices (e.g., PDAs), cellular telephone devices and web-based telephone sets (e.g., “Web-TV”), collectively referred to herein as the consumer's computer or the computer.

The host server 210 is any type of computer server capable of supporting a web site and web-based management tool. The operating system used to run host server 210 and programming used in implementing the method of one embodiment are stored in unillustrated memory resident with host server 210. The operating system and stored programming used in implementing the method of one embodiment can be any operating system or programming language.

The various hardware and software components of system 200 communicate, in one embodiment, via the Internet 240, to implement the method of the present invention. Although not depicted, Internet 240 access by consumer's 220 computer could be implemented via an Internet Service Provider (ISP), a direct dial-up modem connection, a digital subscriber link (DSL), a dedicated T-1 connection, a wireless local area network connection (WLAN), a cellular signal or satellite relay, or any other communication link.

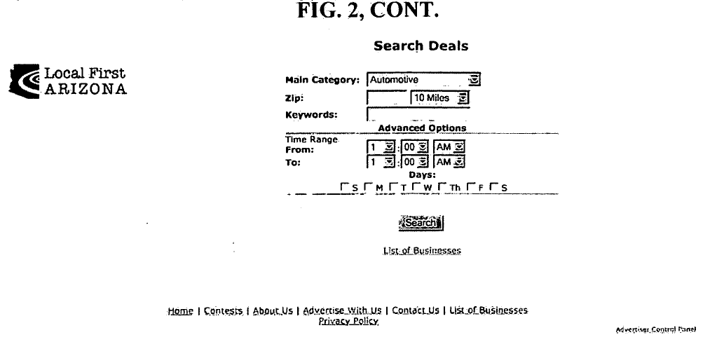

As shown in FIG. 1, the consumer 220 access the search system of the present disclosure as described in more detail with reference to the additional figures. Specifically, consumer 220 is able to access the search system home page, a non-limiting example of which is shown in FIG. 2, of the host web site stored on host server 210 through accessing the search system's URL (Uniform Resource Locator). URL access may occur by numerous and varied methods. By way of example, the consumer 220 may type the desired URL directly into the browser. In addition, the consumer 220 may access the URL by selecting a hyperlink displayed on another web site or web page that links the consumer 220 computer to the home page. Hyperlinks displayed on a web page transfer the consumer 220 to a different web site or web page when selected by the consumer 220.

The hyperlink to the home page may be included as part of an email message displayed by the consumer's 220 computer. The consumer 220 further may access the website from the list of frequently-used sites he or she may have stored as “favorites.” The consumer 220 can also search the Internet 240 for the search system web site using key terms in any Internet search engine such as Google. In any of these examples, when the consumer 220 selects the hyperlink, the consumer 220 computer is directed to the home page. The search system home page is then displayed on consumer's 220 computer screen. Once the consumer 220 has the home page displayed, the consumer 220 can begin using the search system and searching for offers as described below.

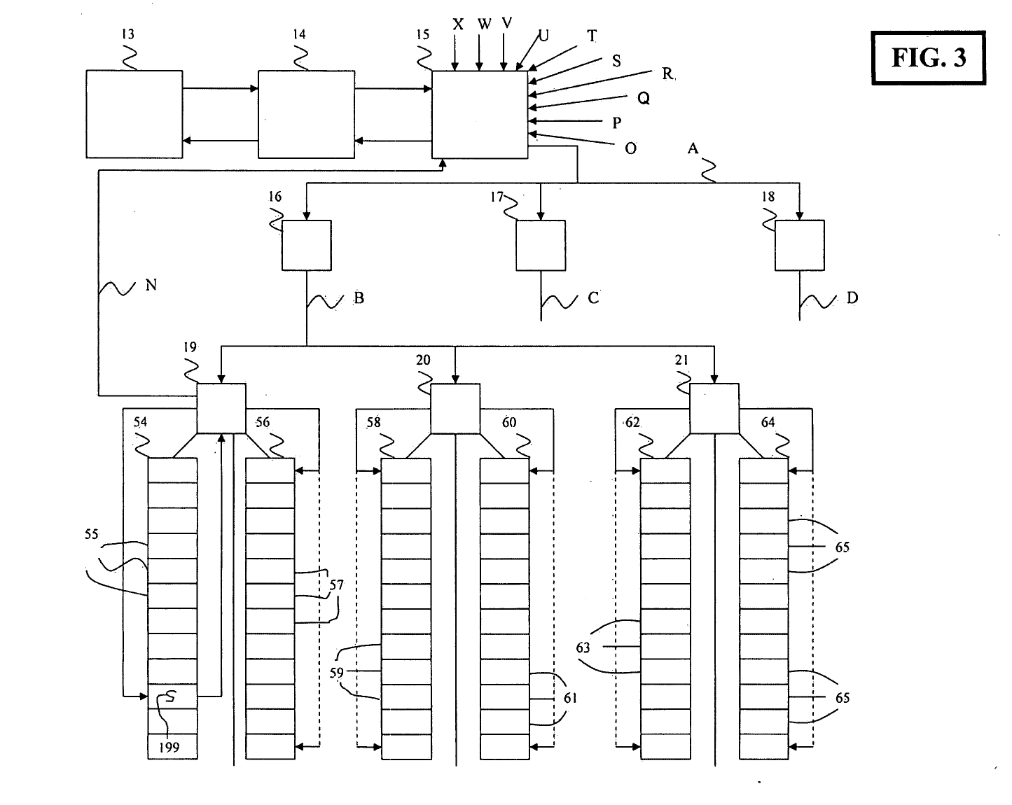

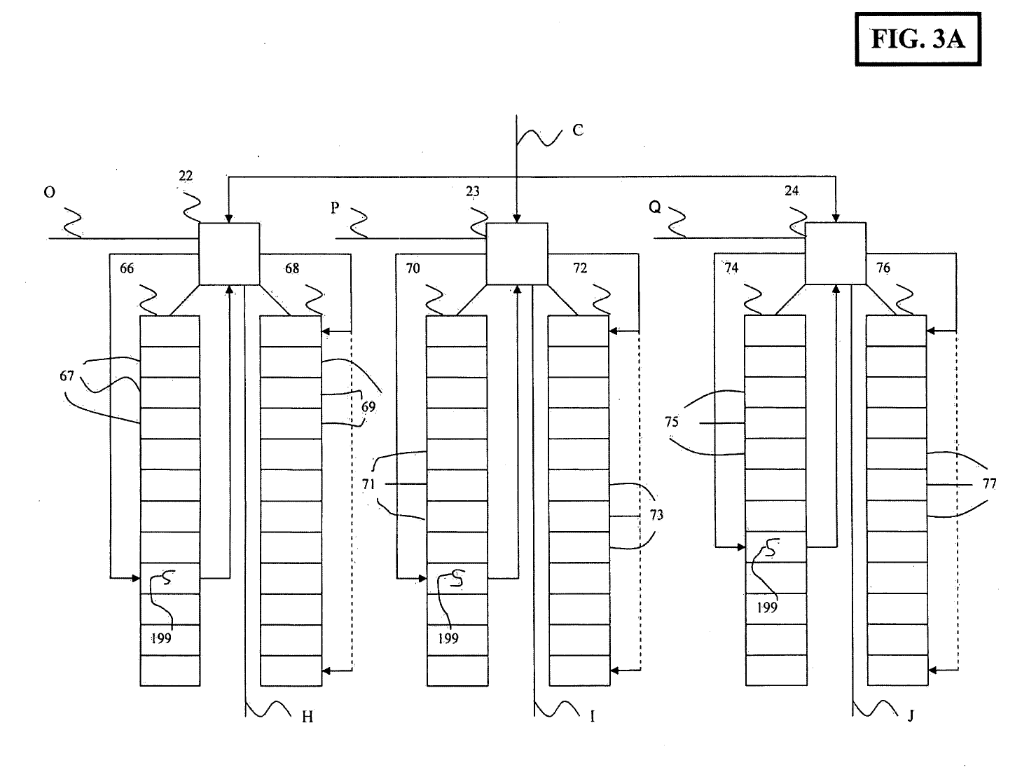

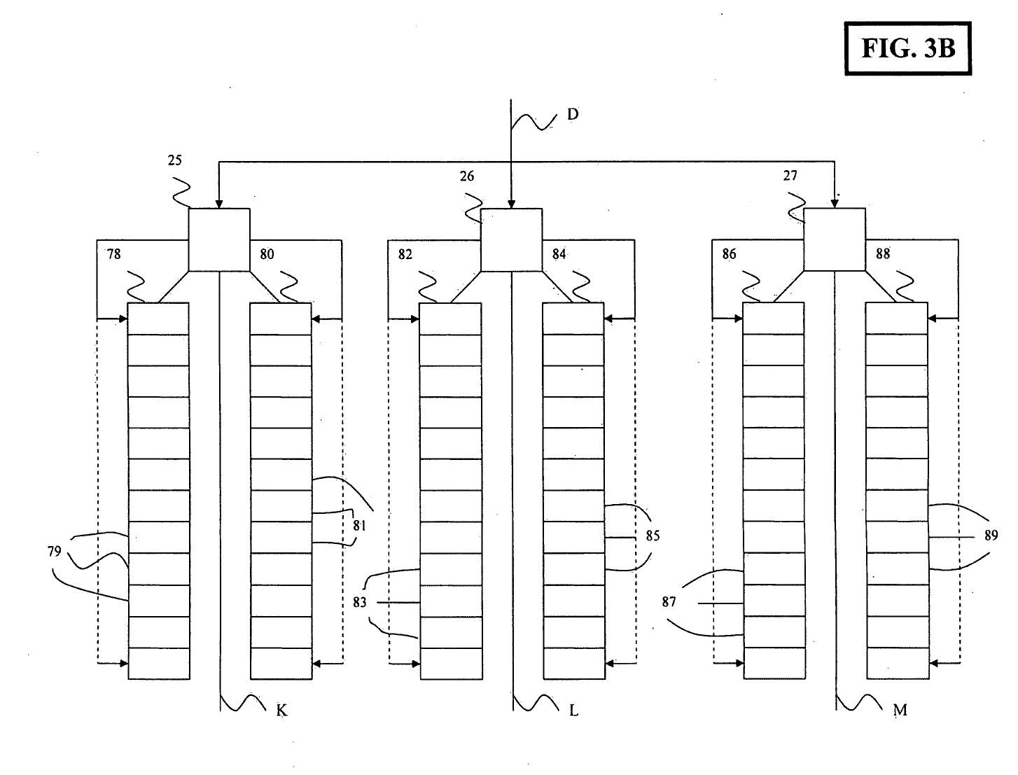

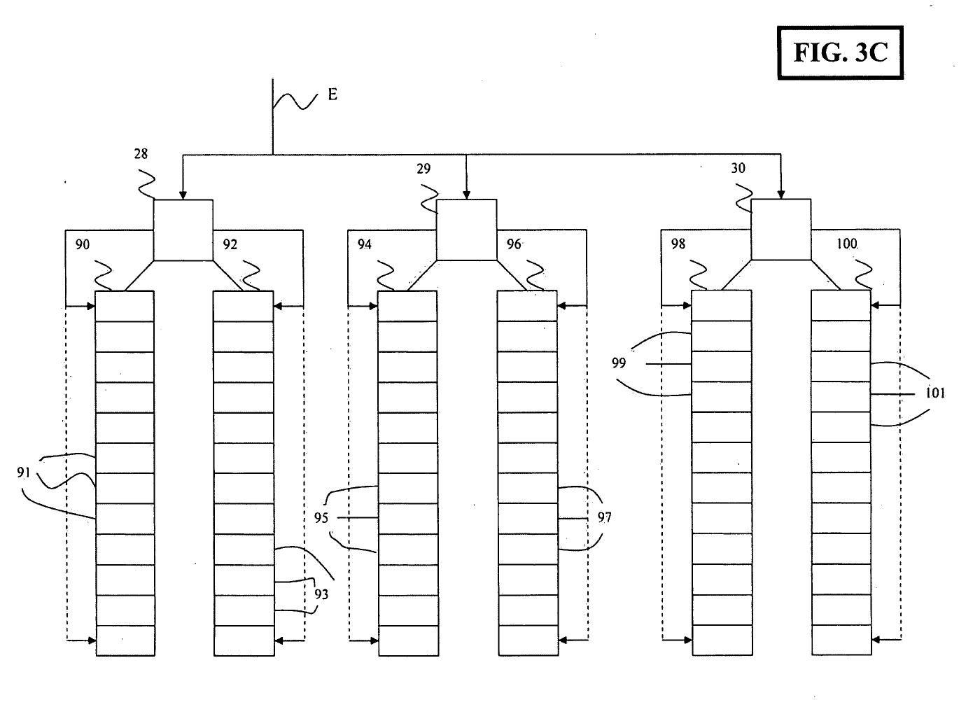

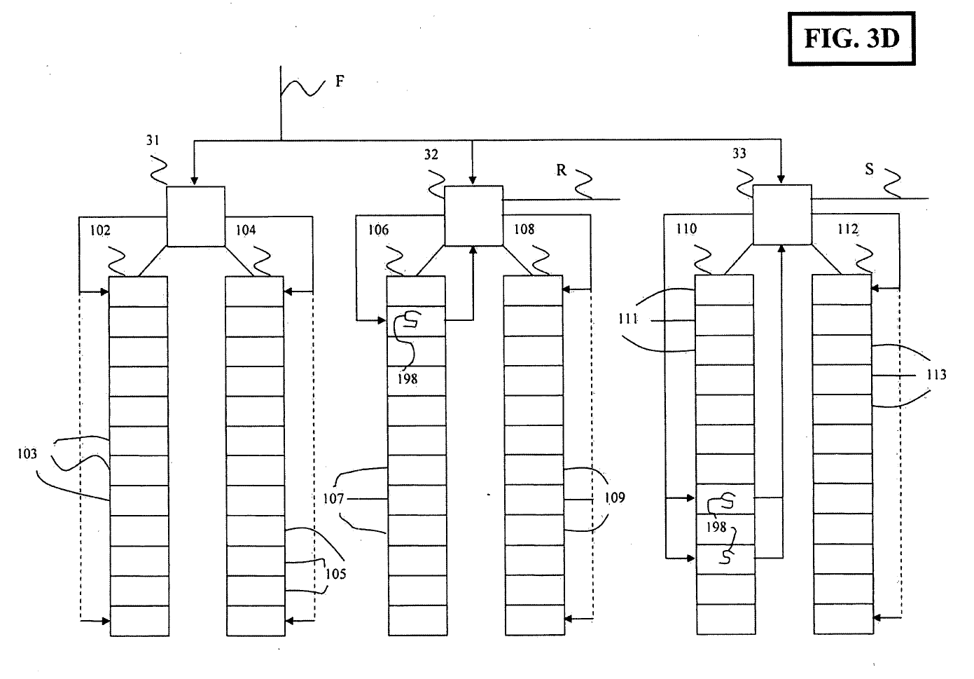

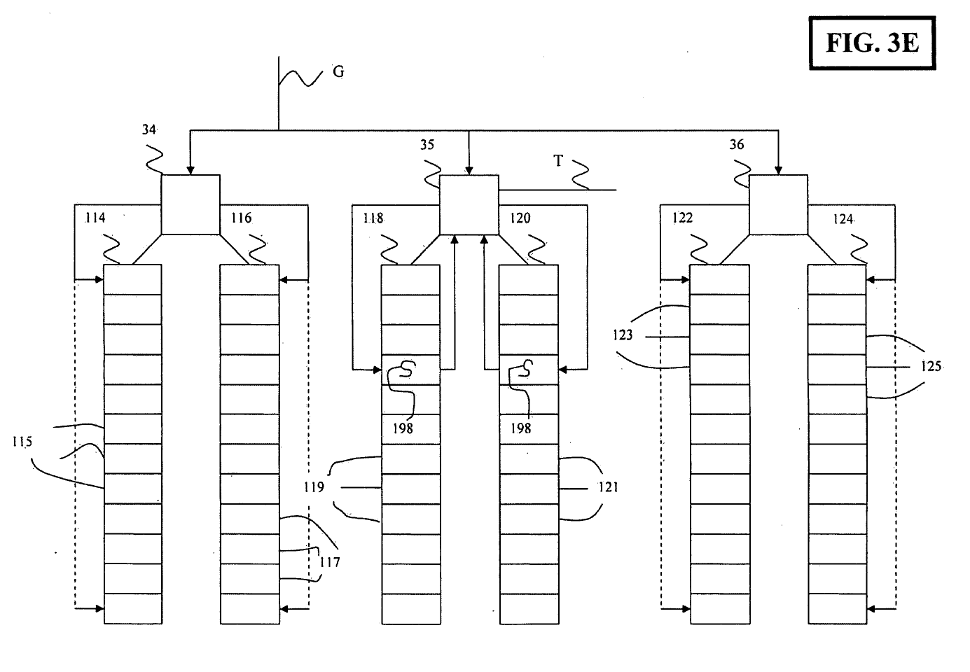

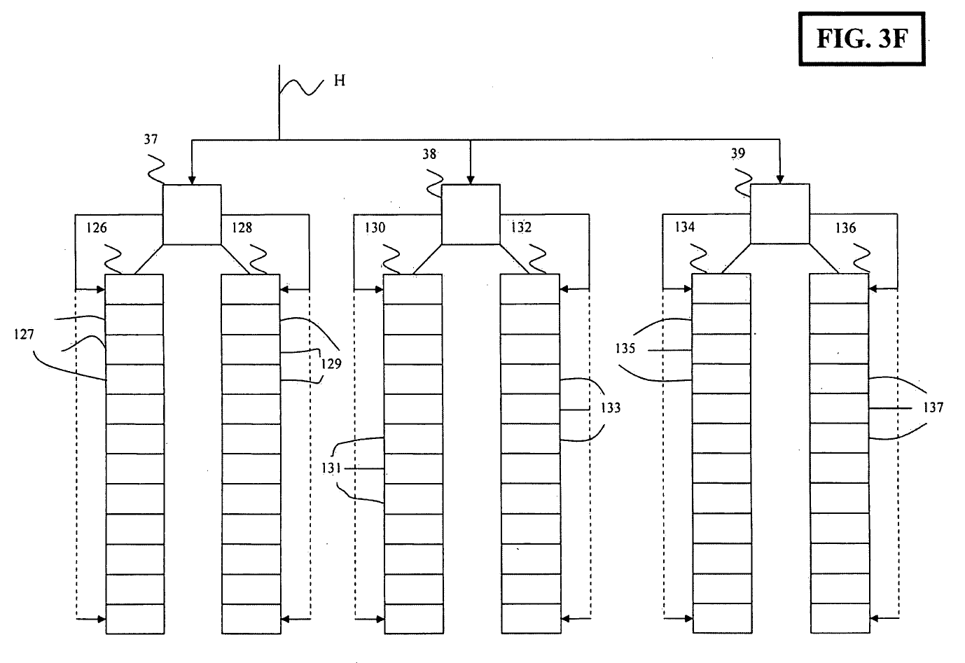

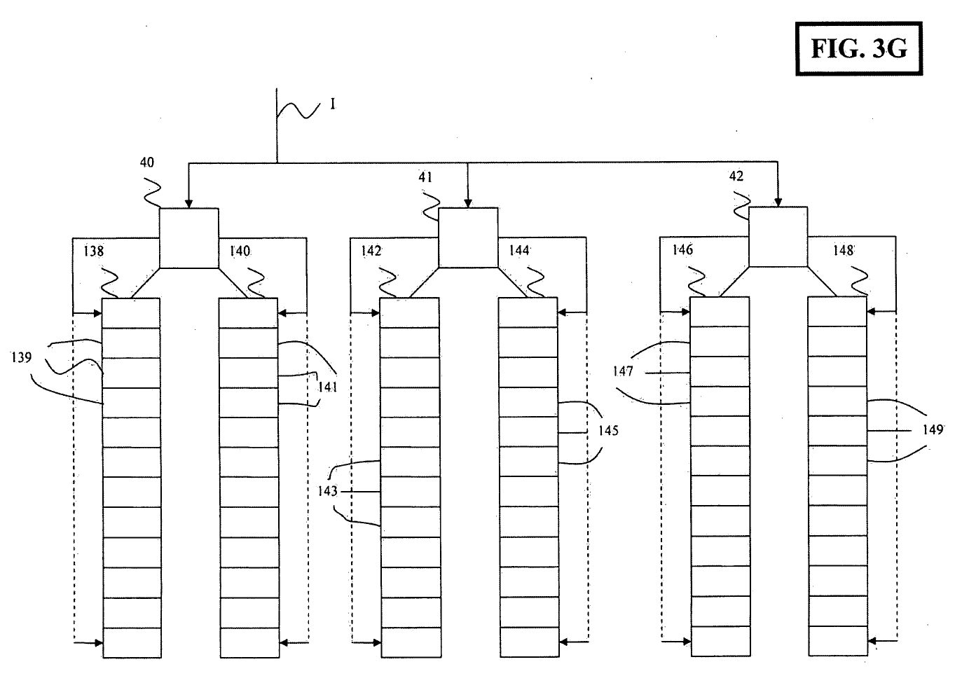

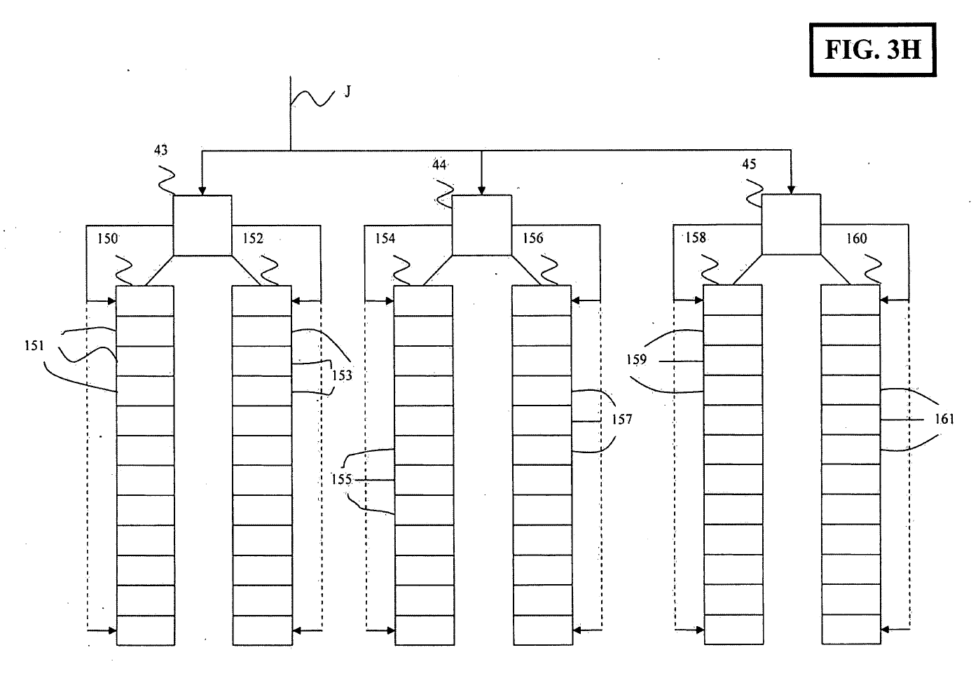

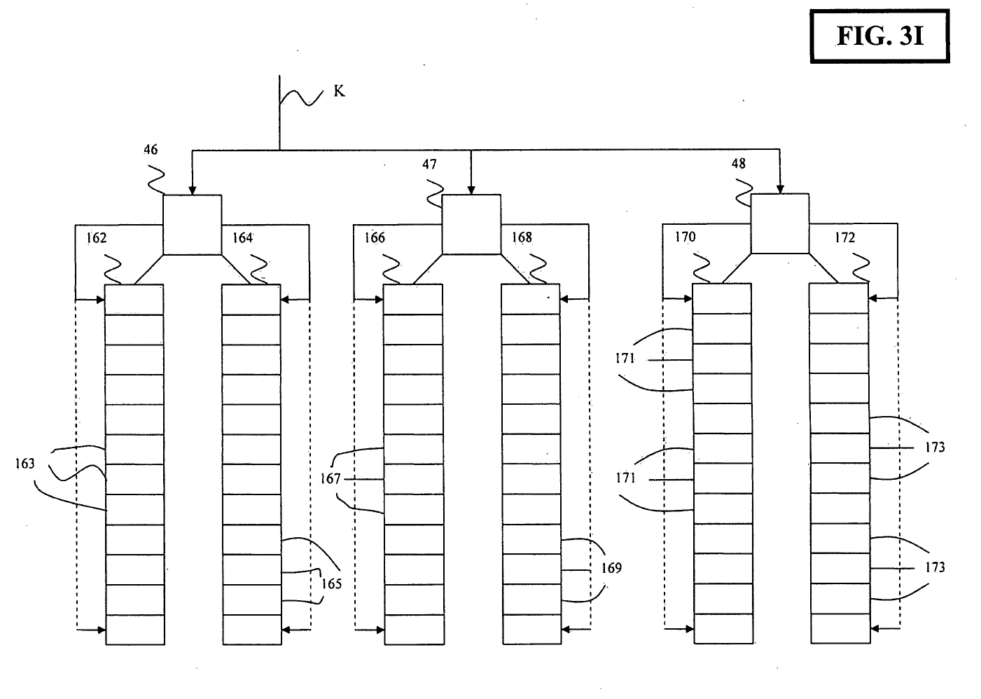

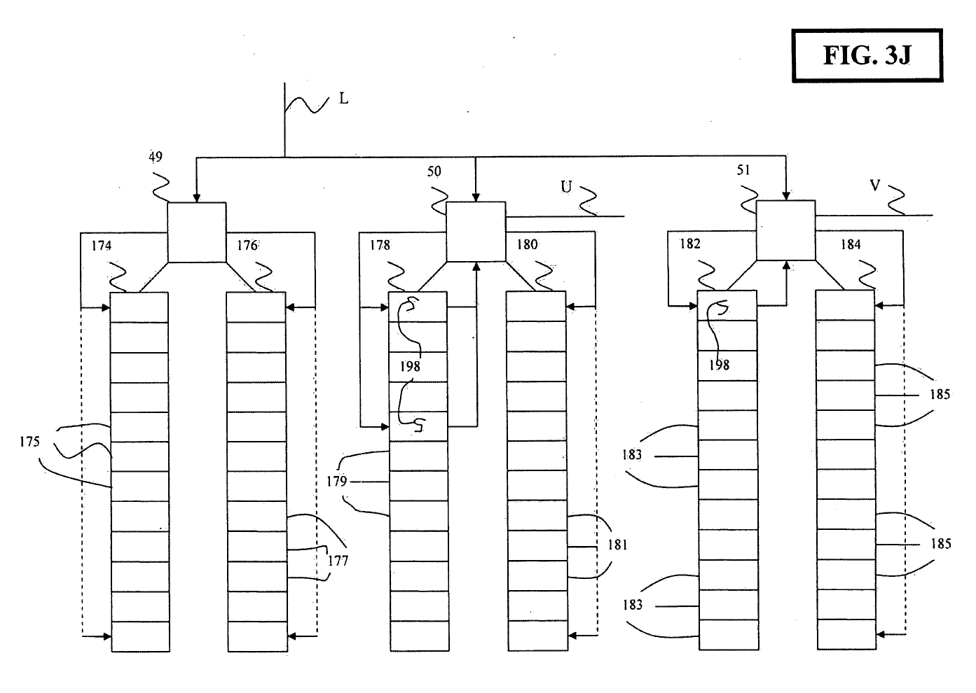

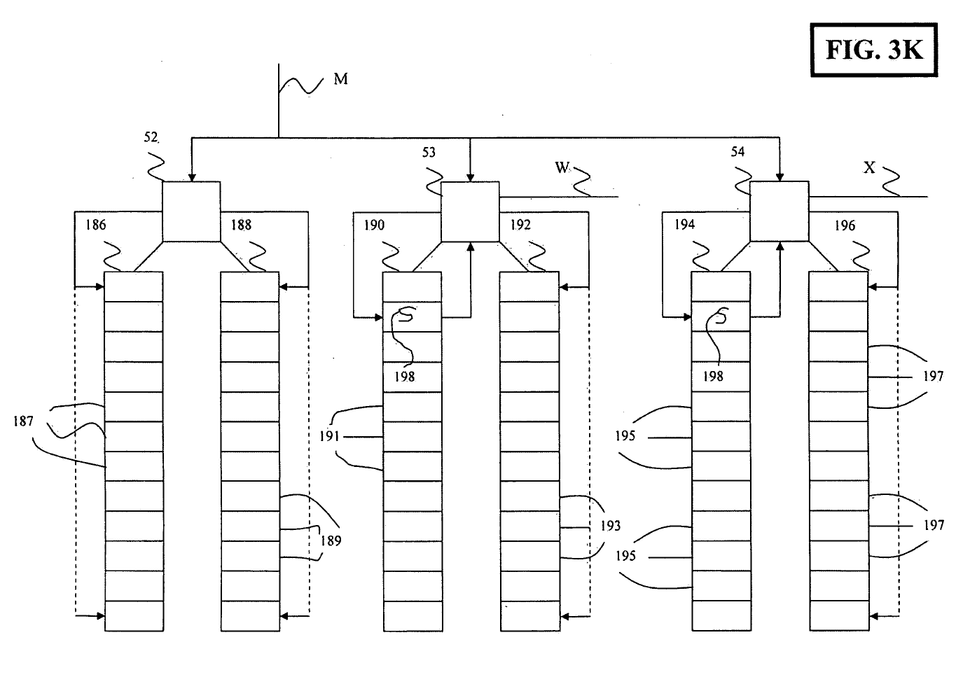

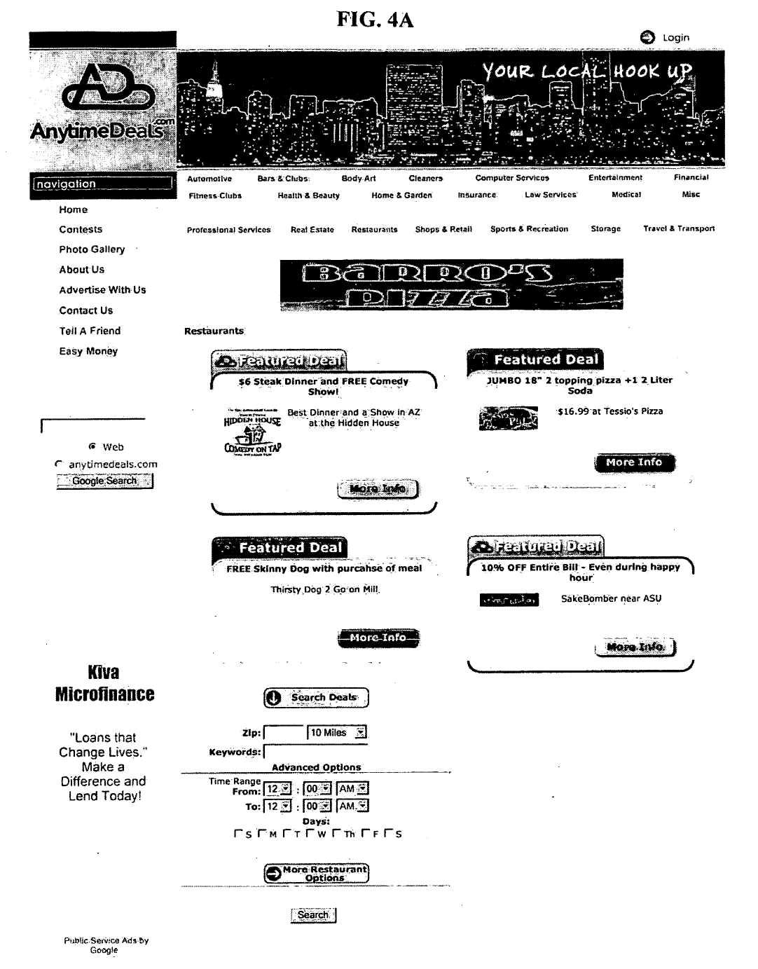

With reference to FIG. 3, and more specifically, as described below, referencing FIGS. 3, and 3A through 3K, in which is illustrated the method of finding business offers and operating hours in accordance with the teachings of the present disclosure, there is first seen a searcher 13 addressing computer 14 and accessing search system 15. Searcher 13 enters input data describing the desired business or business offer. For purposes of illustration, it will be assumed the input data is searching three businesses with each having three locations and three offers per location. In response to the input data, search system 15 transmits the data to business 16, business 17, and business 18 as indicated by the arrowed line A.

Input data is similarly transmitted to business 16 locations 19, 20, and 21 as indicated by the arrowed line B. Location 19 has a schedule 54 listing a plurality of open days and times 55. Location 19 also has a schedule 56 listing a plurality of unique open days and times 57 such as holiday hours. Location 20 has a schedule 58 listing a plurality of open days and times 59. Location 20 also has a schedule 60 listing a plurality of unique open days and times 61 such as holiday hours. Location 21 has a schedule 62 listing a plurality of open days and times 63. Location 21 also has a schedule 64 listing a plurality of unique open days and times 65 such as holiday hours.

Input data is also transmitted to location 19 offers 28, 29, and 30 as indicated by the arrowed line E. Offer 28 has a schedule 90 listing a plurality of valid days and times 91. Offer 28 also has a schedule 92 listing a plurality of unique valid days and times 93 such as holiday hours. Offer 29 has a schedule 94 listing a plurality of valid days and times 95. Offer 29 also has a schedule 96 listing a plurality of unique valid days and times 97 such as holiday hours. Offer 30 has a schedule 98 listing a plurality of valid days and times 99. Offer 30 also has a schedule 100 listing a plurality of unique valid days and times 101 such as holiday hours.

Input data is also transmitted to location 20 offers 31, 32, and 33 as indicated by the arrowed line F. Offer 31 has a schedule 102 listing a plurality of valid days and times 103. Offer 31 also has a schedule 104 listing a plurality of unique valid days and times 105 such as holiday hours. Offer 32 has a schedule 106 listing a plurality of valid days and times 107. Offer 32 also has a schedule 108 listing a plurality of unique valid days and times 109 such as holiday hours. Offer 33 has a schedule 110 listing a plurality of valid days and times 111. Offer 33 also has a schedule 112 listing a plurality of unique valid days and times 113 such as holiday hours. Input data is also transmitted to location 21 offers 34, 35, and 36 as indicated by the arrowed line G.

Offer 34 has a schedule 114 listing a plurality of valid days and times 115. Offer 34 also has a schedule 116 listing a plurality of unique valid days and times 117 such as holiday hours. Offer 35 has a schedule 118 listing a plurality of valid days and times 119. Offer 35 also has a schedule 120 listing a plurality of unique valid days and times 121 such as holiday hours. Offer 36 has a schedule 122 listing a plurality of valid days and times 123. Offer 36 also has a schedule 124 listing a plurality of unique valid days and times 125 such as holiday hours.

Input data is similarly transmitted to business 17 locations 22, 23, and 24 as indicated by the arrowed line C. Location 22 has a schedule 66 listing a plurality of open days and times 67. Location 22 also has a schedule 68 listing a plurality of unique open days and times 69 such as holiday hours. Location 23 has a schedule 70 listing a plurality of open days and times 71. Location 23 also has a schedule 72 listing a plurality of unique open days and times 73 such as holiday hours. Location 24 has a schedule 74 listing a plurality of open days and times 75. Location 24 also has a schedule 76 listing a plurality of unique open days and times 77 such as holiday hours.

Input data is also transmitted to location 22 offers 37, 38, and 39 as indicated by the arrowed line H. Offer 37 has a schedule 126 listing a plurality of valid days and times 127. Offer 37 also has a schedule 128 listing a plurality of unique valid days and times 129 such as holiday hours. Offer 38 has a schedule 130 listing a plurality of valid days and times 131. Offer 38 also has a schedule 132 listing a plurality of unique valid days and times 133 such as holiday hours. Offer 39 has a schedule 134 listing a plurality of valid days and times 135. Offer 39 also has a schedule 136 listing a plurality of unique valid days and times 137 such as holiday hours.

Input data is also transmitted to location 23 offers 40, 41, and 42 as indicated by the arrowed line I. Offer 40 has a schedule 138 listing a plurality of valid days and times 139. Offer 40 also has a schedule 140 listing a plurality of unique valid days and times 141 such as holiday hours. Offer 41 has a schedule 142 listing a plurality of valid days and times 143. Offer 41 also has a schedule 144 listing a plurality of unique valid days and times 145 such as holiday hours. Offer 42 has a schedule 146 listing a plurality of valid days and times 147. Offer 42 also has a schedule 148 listing a plurality of unique valid days and times 149 such as holiday hours. Input data is also transmitted to location 24 offers 43, 44, and 45 as indicated by the arrowed line J.

Offer 43 has a schedule 150 listing a plurality of valid days and times 151. Offer 43 also has a schedule 152 listing a plurality of unique valid days and times 153 such as holiday hours. Offer 44 has a schedule 154 listing a plurality of valid days and times 155. Offer 44 also has a schedule 156 listing a plurality of unique valid days and times 157 such as holiday hours. Offer 45 has a schedule 158 listing a plurality of valid days and times 159. Offer 45 also has a schedule 160 listing a plurality of unique valid days and times 161 such as holiday hours.

Input data is similarly transmitted to business 18 locations 25, 26, and 27 as indicated by the arrowed line D. Location 25 has a schedule 78 listing a plurality of open days and times 79. Location 25 also has a schedule 80 listing a plurality of unique open days and times 81 such as holiday hours. Location 26 has a schedule 82 listing a plurality of open days and times 83. Location 26 also has a schedule 84 listing a plurality of unique open days and times 85 such as holiday hours. Location 27 has a schedule 86 listing a plurality of open days and times 87. Location 27 also has a schedule 88 listing a plurality of unique open days and times 89 such as holiday hours.

Input data is also transmitted to location 25 offers 46, 47, and 48 as indicated by the arrowed line K. Offer 46 has a schedule 162 listing a plurality of valid days and times 163. Offer 46 also has a schedule 164 listing a plurality of unique valid days and times 165 such as holiday hours. Offer 47 has a schedule 166 listing a plurality of valid days and times 167. Offer 47 also has a schedule 168 listing a plurality of unique valid days and times 169 such as holiday hours. Offer 48 has a schedule 170 listing a plurality of valid days and times 171. Offer 48 also has a schedule 172 listing a plurality of unique valid days and times 173 such as holiday hours.

Input data is also transmitted to location 26 offers 49, 50, and 51 as indicated by the arrowed line L. Offer 49 has a schedule 174 listing a plurality of valid days and times 175. Offer 49 also has a schedule 176 listing a plurality of unique valid days and times 177 such as holiday hours. Offer 50 has a schedule 178 listing a plurality of valid days and times 179. Offer 50 also has a schedule 180 listing a plurality of unique valid days and times 181 such as holiday hours. Offer 51 has a schedule 182 listing a plurality of valid days and times 183. Offer 51 also has a schedule 184 listing a plurality of unique valid days and times 185 such as holiday hours.

Input data is also transmitted to location 27 offers 52, 53, and 54 as indicated by the arrowed line M. Offer 52 has a schedule 186 listing a plurality of valid days and times 187. Offer 52 also has a schedule 188 listing a plurality of unique valid days and times 189 such as holiday hours. Offer 53 has a schedule 190 listing a plurality of valid days and times 191. Offer 53 also has a schedule 192 listing a plurality of unique valid days and times 193 such as holiday hours. Offer 54 has a schedule 194 listing a plurality of valid days and times 195. Offer 54 also has a schedule 196 listing a plurality of unique valid days and times 197 such as holiday hours.

In further response to the input data, offer 28 scans associated schedules 90 and 92, offer 29 scans associated schedules 94 and 96, offer 30 scans associated schedules 98 and 100, offer 31 scans associated schedules 102 and 104, offer 32 scans associated schedules 106 and 108, offer 33 scans associated schedules 110 and 112, offer 34 scans associated schedules 114 and 116, offer 35 scans associated schedules 118 and 120, offer 36 scans associated schedules 122 and 124, offer 37 scans associated schedules 126 and 128, offer 38 scans associated schedules 130 and 132, offer 39 scans associated schedules 134 and 136, offer 40 scans associated schedules 138 and 140, offer 41 scans associated schedules 142 and 144, offer 42 scans associated schedules 146 and 148, offer 43 scans associated schedules 150 and 152, offer 44 scans associated schedules 154 and 156, offer 45 scans associated schedules 158 and 160, offer 46 scans associated schedules 162 and 164, offer 47 scans associated schedules 166 and 168, offer 48 scans associated schedules 170 and 172, offer 49 scans associated schedules 174 and 176, offer 50 scans associated schedules 178 and 180, offer 51 scans associated schedules 182 and 184, offer 52 scans associated schedules 186 and 188, offer 53 scans associated schedules 190 and 192, and offer 54 scans associated schedules 194 and 196. Schedules 106, 110, 118, 120, 178, 182, 190, and 194 include valid offers relative to the input data during the specified day and time range as designated by the reference characters 198.

This data is then transmitted to each schedules respective offer. Schedule 106 transmits to offer 32 which, in turn, transmits the data to search system 15, computer 14 and subsequently to searcher 13 as indicated by the arrowed line R. Schedule 110 transmits to offer 33 which, in turn, transmits the data to search system 15, computer 14 and subsequently to searcher 13 as indicated by the arrowed line S. Schedules 118 and 120 transmit to offer 35 which, in turn, transmits the data to search system 15, computer 14 and subsequently to searcher 13 as indicated by the arrowed line T. Schedule 178 transmits to offer 50 which, in turn, transmits the data to search system 15, computer 14 and subsequently to searcher 13 as indicated by the arrowed line U. Schedule 182 transmits to offer 51 which, in turn, transmits the data to search system 15, computer 14 and subsequently to searcher 13 as indicated by the arrowed line V. Schedule 190 transmits to offer 53 which, in turn, transmits the data to search system 15, computer 14 and subsequently to searcher 13 as indicated by the arrowed line W. Schedule 194 transmits to offer 54 which, in turn, transmits the data to search system 15, computer 14 and subsequently to searcher 13 as indicated by the arrowed line X.

Alternatively the searcher may desire to search businesses and its locations by their open hours rather than by specific valid business offers. The input data will scan the locations schedules of open days and times similarly to how the first input data scanned each business offer schedule. In this instance the only response difference will be which schedules are scanned. With new input data searching for open businesses schedules 54, 66, 70, and 74 include open hours during the specified day and time range as designated by the reference characters 199. This data is then transmitted to each schedules respective location. Schedule 54 transmits to location 19, which, in turn, transmits the data to search system 15, computer 14 and subsequently to searcher 13 as indicated by the arrowed line N. Schedule 66 transmits to location 22 which, in turn, transmits the data to search system 15, computer 14 and subsequently to searcher 13 as indicated by the arrowed line O. Schedule 70 transmits to location 23 which, in turn, transmits the data to search system 15, computer 14 and subsequently to searcher 13 as indicated by the arrowed line P. Schedule 74 transmits to location 24 which, in turn, transmits the data to search system 15, computer 14 and subsequently to searcher 13 as indicated by the arrowed line Q.

Turning now to FIGS. 4A-4C, FIG. 4A illustrates one embodiment of the search system as the potential searcher would view it on consumer 220 computer. The particular example provided in FIG. 4A is for restaurants. However, as noted above, and shown in FIG. 2, this is only one of many potential and unlimited categories for searching, and is used here by way of example only. As shown in FIG. 4A, the searcher has the option of providing different data inputs. The potential data inputs may include, but are not limited to, location (by zip code, city, address, and so on), distance from chosen location, time or time range, dates or days of the week. The particular input data points shown in FIG. 4A are by way of example only, and it is noted that other data inputs that accomplish the same goals of the present disclosure may be used.

FIGS. 4B and 4C also illustrate alternate embodiments of the search system and input data user entry fields as displayed to the consumer via the host server website and particular search webpage. While FIG. 4B has less criteria and is more of a basic search, FIG. 4C illustrates an advanced search feature of the disclosed search system that allows for additional defining user inputs and return of business offers that meet more specific criteria.

For example, an advanced search, as shown in FIG. 4C, allows a consumer to find bar and grills that serve barbeque and allow patrons under 18 years of age after 7 pm. This feature is of particular usefulness to a group consumers of varying age, such as a family with children, who want to have a barbeque dinner with the children, but are unsure if children are allowed in after 7 pm. Search features such as this on the presently disclosed search system allow consumers to avoid calling or looking up each restaurant to determine whether that restaurant will meet their needs—or from arriving at a restaurant only to be turned away or disappointed.

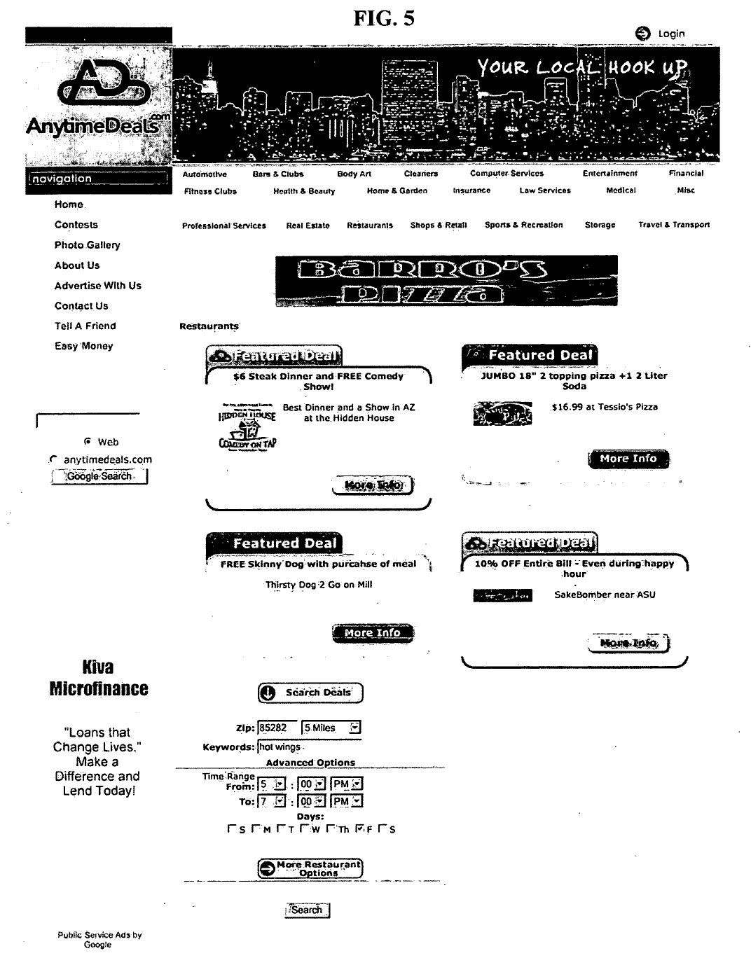

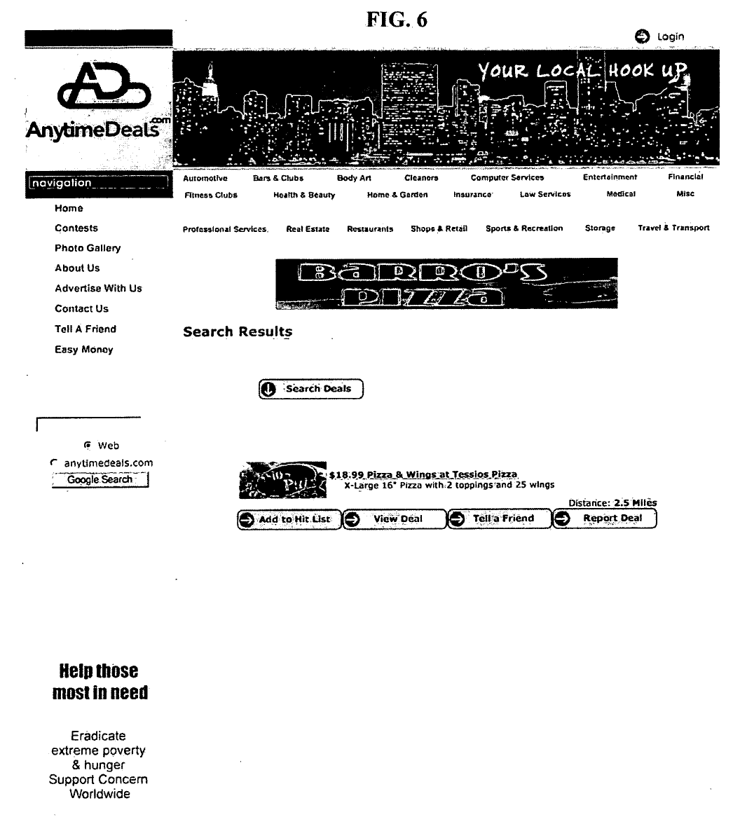

As shown in FIG. 5, the searcher enters particular data into the search fields indicating a desire for hot wings from 5 pm to 7 pm on Friday within 5 miles of zip code 85282. FIG. 6 illustrates the results returned to the searcher upon selecting “search deals.”

Also note, as illustrated in FIG. 5, that the present disclosure provides for additional opportunities for businesses to advertise “featured deals” or other deals before the searcher initiates the search, and as shown in FIG. 6, even after the searcher has completed the search. The present system also includes a searching mechanism for return of featured deals based either on the consumer's input of date or time, or as described above, based on a “HERE AND NOW” feature. Returning advertisements or featured deals for consumers in a fashion that lists the most relevant results first. Thus, if the consumer selects the HERE AND NOW feature, utilizing the present date and time and/or GPS position, if available, from the computing device as an automatically input parameter, the results returned would either not include or give a very low ranking to businesses that are currently closed. In this manner, the disclosed system also includes additional advertising mechanisms for businesses in the selected category as well as opportunities for those business to provide coupons or other offers to potential consumers.

As disclosed herein, a further searching mechanism used by the search system displays advertisements for other business offers in close proximity to the business offer the consumer originally searched for. For example, a consumer searches for hot wings in Tempe, Ariz. at 5 pm on Friday. The present search system would then generate advertisements or featured deals for other related, but complementary, business offers or specials in Tempe at 5 pm on Friday, such as live music and drink specials.

Further, if there are no business offer results returned in FIG. 6 (or even if business offer results are returned in FIG. 6), in an alternate embodiment, a consumer would have the option of selecting “Show” and displaying all businesses that are consistent with the input data received by the host server, although the businesses returned upon selection of “Show” would not necessarily have discounted business offers or traditional deals on the requested product or service at the time or day requested. Yet, the consumer could still be apprised that the requested good or service is offered at that day and/or time in the desired location for regular price. This feature is most beneficial when attempting to identify particular goods or services such as delivery, live music, age requirements, etc. in a given business category and location.

Additionally more than one type of business category can be searched at one time—allowing consumers to find locations or businesses that offer multiple goods or services at one time and in one location. For example, a consumer could enter input data “drink specials live music;” “Friday;” “10 pm.” The results returned based on the input data parameter would include all businesses with both drink specials and live music on Fridays that spans the 10:00 pm hour (e.g. drink specials from 7 pm to midnight and live music from 9 pm to 11 pm).

It is also envisioned that the present disclosure includes web pages that allow users to post reviews and comments about businesses, deals, offers and other relevant information. This can be through a blog type page, chat room, or other mechanism known in the art. In a further embodiment of the disclosure, this consumer-provided information may also be included in the searchable data. For example, a consumer may be allowed to post a comment about a particular business, not yet in the database, having hot wings from 5 pm to 7 pm. The result, if the criteria of the input data meet that posting, would then also include that particular blog posting or chat entry.

Further, as shown in FIG. 4, the present disclosure also envisions being able to email particular deals to other potential consumers and searchers, as denoted by the “tell a friend” feature shown in FIG. 4.

Finally, the present disclosure also envisions a one-stop shopping feature for groceries and other necessities. A searcher is capable of making a grocery list, entering the day the searcher intends to go shopping, and then the search system will return deals from grocery stores and markets that fit the searcher's criteria or input data. The searcher, then, can scan the return list and either shop each store where a deal is returned or select the one store with the most deals on the particular items needed. Thus, the search system herein eliminates the wasted time of shoppers in scanning each and every flyer or shoppers guide mailed to them.

Therefore, the present system provides a method for consumers for reducing time and effort in searching for day and time based offers, while allowing merchants to more effectively market. This provides consumers the attractive benefit of “one-stop” shopping that, at least in one embodiment, is free of charge. This further provides merchants a mechanism of leveraging consumer intelligence data, which increases sales and allows business resources to be allocated more effectively.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

1. A method for searching for business offers, comprising:
providing to a consumer, from a server computer through a website accessible by a consumer's computer, an array of preferences, the preferences including keyword, location, time and day preferences, wherein the consumer, via the consumer's computer, is capable of communicating preferences to the server computer in the form of input data, the input data including at least a keyword data point, a time data point and a day data point, that when transmitted to the server computer return to the consumer, via the website viewable on the consumer's computer, one or more business offers.

2. The method of claim 1, wherein one or more input data datapoints is transmitted by the consumer computer to the server computer without manual input from the consumer.

3. The method of claim 2, wherein schedules of data reside on the server computer.

4. The method of claim 3, wherein the server computer, in response to the search command executed by the consumer, scans the schedules on the server computer.

5. The method of claim 4, wherein the server computer, following scanning the schedules returns results consistent with the input data points.

6. The method of claim 5, wherein the results returned by the server computer are the business offers.

7. The method of claim 6, wherein the business offers are transmitted from the server computer to the consumer computer, via the website.

8. The method of claim 7, wherein the business offers are displayed as search results on a webpage viewable by consumers so that the business offers are communicated to the consumer.

9. A computer-readable storage medium containing computer executable code for instructing a server computer to perform the steps of:
displaying a webpage to a consumer through a website accessible by a consumer's computer, the webpage providing an array of preferences, the preferences including keyword, location, time and day preferences, wherein the consumer, via the consumer's computer, is capable of communicating preferences to the server computer in the form of input data, the input data including at least a keyword data point, a time data point and a day data point, that when transmitted to the host server return to the consumer, via the website viewable on the consumer's computer, one or more business offers.

10. The computer-readable storage medium of claim 9, further containing computer executable code for instructing a server computer to receive input data from a consumer computer.

11. The computer-readable storage medium of claim 10, further containing computer executable code for instructing a server computer to scan schedules of data, representing business offers, for business offers consistent with the data points received from the consumer computer.

12. The computer-readable storage medium of claim 11, further containing computer executable code for instructing a server computer to return results wherein the results are business offers consistent with the data points received from the consumer computer.

13. The computer-readable storage medium of claim 12, further containing computer executable code for instructing a server computer to transmit and display the results to a webpage viewable on a consumer computer.

14. The computer-readable storage medium of claim 13, further containing computer executable code for instructing a server computer to retrieve input data from the consumer's computing device without manual input from the consumer, the input data selected from a group consisting of date, time and location.

15. A system for searching for business offers comprising:
a server computer including a web site having one or more content-based web pages and in communication with one or more distribution mediums, wherein, in response to a communication from a consumer computer, said server computer provides said consumer computer an array of possible offers from businesses, wherein said consumer computer is operable by a consumer and wherein said consumer presented with an array of preferences, the preferences including keyword, location, time and day preferences, wherein the consumer, via the consumer's computer, is capable of communicating preferences to the server computer in the form of input data, the input data including at least a keyword data point, a time data point and a day data point, that when transmitted to the host server return to the consumer, via the website viewable on the consumer's computer, one or more business offers.

16. The system of claim 15, further comprising, a business computer, in communication with one or more distribution mediums, wherein the business computer in response to a communication from the host server computer, directs said business computer to execute one or more functions in response to the communication.

17. The system of claim 15, further comprising a consumer computer in communication with one or more distribution mediums, wherein the server computer in response to a communication from the consumer computer directs said consumer computer to execute one ore more functions in response to the communication.

18. The method of claim 1, wherein the server computer returns to the consumer, via the website viewable on the consumer's computer, one or more advertisements, in addition to business offers, based on the input data.

19. The method of claim 1, wherein the business is capable of having a portal or link on the website.

20. The method of claim 1, wherein the business offer includes a coupon.
